(19) United States
(12) Patent Application Publication
(10) Pub. No.: US 2023/0371480 A1
(43) Pub. Date: Nov. 23, 2023

(54) AQUARIUM HAVING MULTIPLE COMPARTMENTS AND PANEL ARRANGEMENT(S) BETWEEN THE COMPARTMENTS

(71) Applicant: Spectrum Brands, Inc., Middleton, WI (US)

(72) Inventors: William Nathan BRUNNER, St. Peters, MO (US); William D. HIMES, Radford, VA (US); Anne GIERSE, Ballwin, MO (US); John L. SHUMATE, Shawsville, VA (US)

(73) Assignee: Spectrum Brands, Inc., Middleton, WI (US)

(21) Appl. No.: 18/030,431

(22) PCT Filed: Oct. 4, 2021
(86) PCT No.: PCT/US2021/053334

§ 371 Date: Apr. 5, 2023

Related U.S. Application Data
(60) Provisional application No. 63/088,279, filed on Oct. 6, 2020.

(51) Int. Cl. A01K 63/06; A01K 63/04

(52) U.S. Cl. CPC A01K 63/06; A01K 63/045

(57) ABSTRACT

An aquarium includes a tank and at least a first opaque panel dividing the tank interior volume into at least 2 separate compartments. A canopy covers the tank, and a lighting assembly is secured to an interior portion of the canopy. A filter arrangement is provided in communication with the interior volume of the tank.

### CROSS-REFERENCE TO RELATED APPLICATION

This application is a PCT International Patent Application and claims priority to U.S. Provisional Patent Application No. 63/088,279, filed Oct. 6, 2020, the disclosure of which is hereby incorporated by reference in its entirety.

### TECHNICAL FIELD

This disclosure relates to aquariums. In particular, this disclosure relates to aquariums having multiple compartments with opaque panel(s) therebetween.

### BACKGROUND

Many individuals enjoy keeping different species of fish, such as betta fish, as pets. Betta fish tend to be aggressive when kept in captivity with other betta fish and/or other species of fish. Therefore, it is oftentimes necessary to keep betta fish separate and apart from each other and/or other fish.

There exists in the art a need for an attractive aquarium device that enables a pet owner to accommodate a number of betta fish in a segregated manner for a prolonged period of time.

### SUMMARY

An aquarium is provided which improves the prior art.

An aquarium is provided comprising: (a) a tank having an outer surrounding wall defining an interior volume; (b) at least a first opaque panel in the interior volume and dividing the interior volume into at least 2 separate compartments; (c) a canopy covering the tank; the canopy having an interior portion facing the interior volume of the tank; (d) a lighting assembly secured to the interior portion of the canopy; and (e) a filter arrangement in communication with the interior volume of the tank.

The aquarium may further comprise a second opaque panel in the interior volume and spaced from the first opaque panel, to divide the interior volume into 3 separate compartments; the 3 separate compartments including a first compartment, second compartment, and third compartment.

The first opaque panel can include a frosted panel.

In preferred embodiments, both the first opaque panel and second opaque panel comprises a frosted panel.

In some arrangements, the first opaque panel includes a first through opening covered with a filter.

Some embodiments will include the first opaque panel with a plurality of through slots adjacent an upper edge of the first panel.

The aquarium can further include a third panel extending between and connecting the first opaque panel and second opaque panel, such that the second compartment is defined by the first opaque panel, third panel, second opaque panel, and a portion of the surrounding wall of the tank.

The filter arrangement can be positioned in a filter chamber defined between a portion of the surrounding wall and the third panel.

The third panel may have a connection arrangement along opposite side edges forming a releasable attachment with the first opaque panel and second opaque panel.

In one or more examples, the connection arrangement includes a plurality of tabs projecting from the opposite side edges of the third panel and slots defined by the first opaque panel and second opaque panel.

In some embodiments, the first opaque panel includes a first through opening covered with a filter; the first through opening extending between the first compartment and the filter chamber; the second opaque panel includes a second through opening covered with a filter; the second through opening extending between the third compartment and the filter chamber; and the third panel includes at least a third through opening covered with a filter; the third through opening extending between the second compartment and the filter chamber.

In example arrangements, the third panel includes a fourth through opening covered with a filter; the fourth through opening extending between the second compartment and the filter chamber.

In some examples, the first opaque panel includes a plurality of through slots adjacent an upper edge of the first opaque panel; and the second opaque panel includes a plurality of through slots adjacent an upper edge of the second opaque panel.

In preferred arrangements, the canopy comprises plastic.

In some examples, the lighting assembly includes LED lights.

The filter arrangement may include a waterfall in the interior volume of the tank.

In many embodiments, the canopy is pivotably attached to the tank.

In another aspect, an aquarium system is provided including: (a) a tank having an outer surrounding wall defining an interior volume; the tank holding water; (b) at least a first opaque panel in the interior volume and dividing the interior volume into at least first and second compartments; (c) a canopy covering the tank; the canopy having an interior portion facing the interior volume of the tank; (d) a lighting assembly secured to an interior portion of the canopy; (e) a filter arrangement in communication with the interior volume of the tank; (f) a first fish in the first compartment; and (g) a second fish in the second compartment; wherein the first opaque panel precludes the first fish and second fish from seeing each other.

The aquarium system may further comprise: a second opaque panel in the interior volume and spaced from the first opaque panel, to further divide the interior volume into a third compartment; and a third fish in the third compartment.

In many embodiments, the first fish and second fish are Betta fish.

A variety of examples of desirable product features or methods are set forth in the description that follows, and in part, will be apparent from the description, or may be learned by practicing various aspects of this disclosure. The aspects of this disclosure may relate to individual features, as well as combinations of features. It is to be understood that booth the foregoing general description, and the following detailed description, are explanatory only, and are not restrictive of the claimed inventions.

### BRIEF DESCRIPTION OF THE DRAWINGS

FIG. 1 is a top, perspective view of an embodiment of an aquarium, constructed in accordance with principles of this disclosure;

FIG. 2 is an exploded, perspective view of the aquarium of FIG. 1;

FIG. 3 is a front view of the aquarium of FIG. 1;

FIG. 4 is a rear view of the aquarium of FIG. 1;

FIG. 5 is a right side view of the aquarium of FIG. 1;

FIG. 6 is a left side view of the aquarium of FIG. 1;

FIG. 7 is a top plan view of the aquarium of FIG. 1;

FIG. 8 is a bottom plan view of the aquarium of FIG. 1; and

FIG. 9 is a bottom perspective view of the aquarium of FIG. 1.

### DETAILED DESCRIPTION

An aquarium made in accordance with principles of this disclosure is shown in the FIGS. generally at 10. The aquarium 10 includes a tank 12. While the tank 12 can be made from a variety of materials, it is preferable that the tank 12 be made from a transparent material and preferably from plastic or glass.

The tank 12 includes an outer surrounding wall 14. The surrounding wall 14 can have a variety of shapes. In the example embodiment shown, the surrounding wall 14 has a generally rectangular shape, which includes opposing front and rear walls 16, 18 joined by opposing first and second side walls 20, 22 with generally rounded corners. The surrounding wall 14 extends from a flat or planar bottom 24. The bottom 24 can be made from any strong, rigid material, including a rigid plastic.

The surrounding wall 14 defines an interior volume 26 therein. The interior volume 26 is sized to hold, for example, water in a sufficient amount in order to sustain one or more aquatic animals, such as fish. In other embodiments, the interior volume 26 will not hold water, but can hold other plants or animals including reptiles, arachnoids, or various insects.

A canopy 28 covers the tank 12. The canopy 28 has an interior portion 30 (FIG. 9) facing the interior volume 26 of the tank 12.

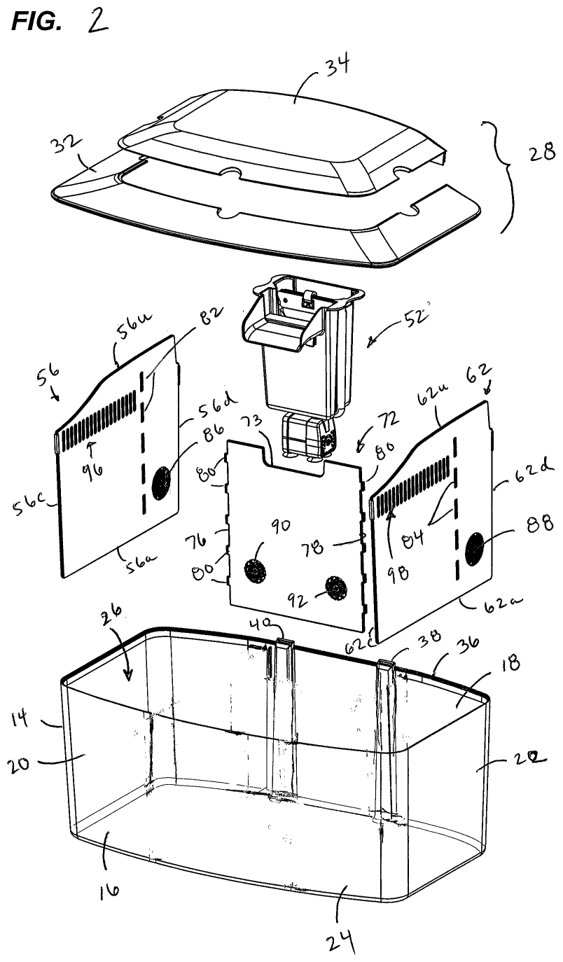

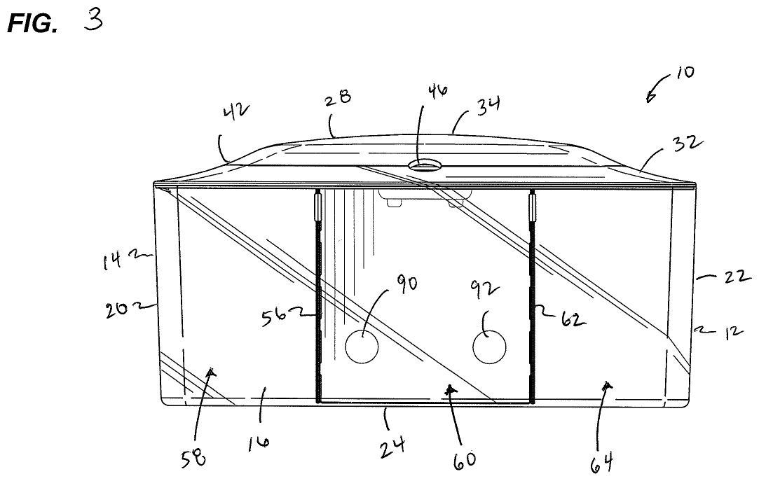

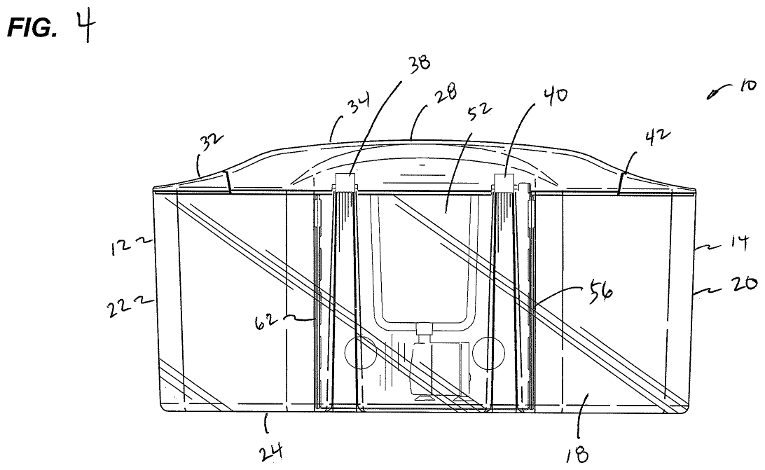

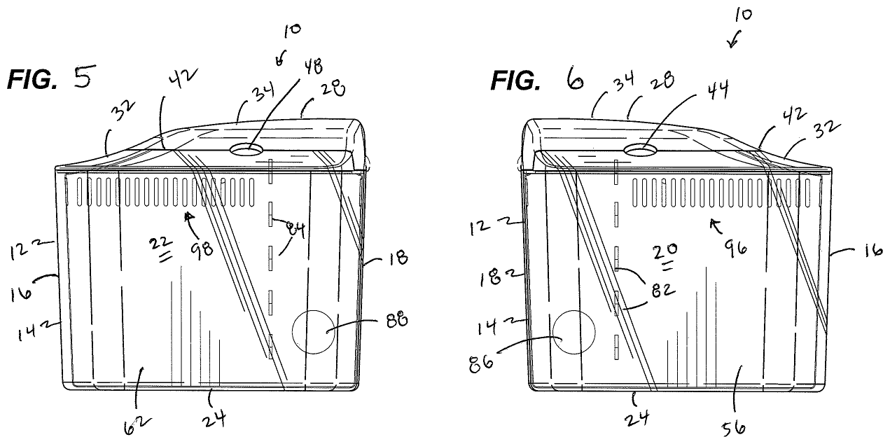

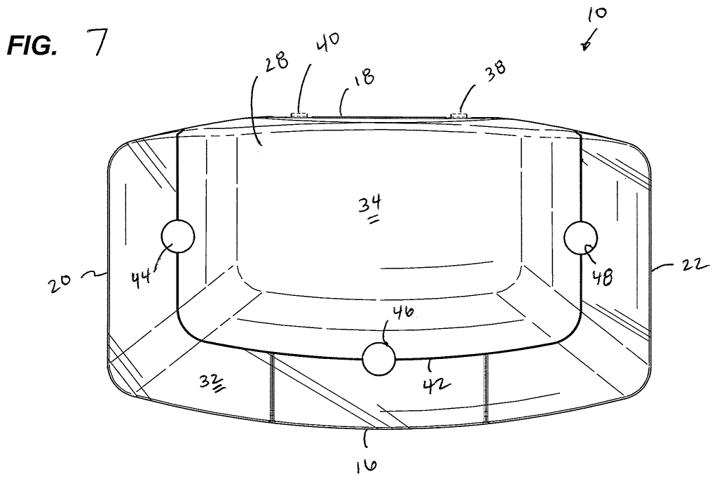

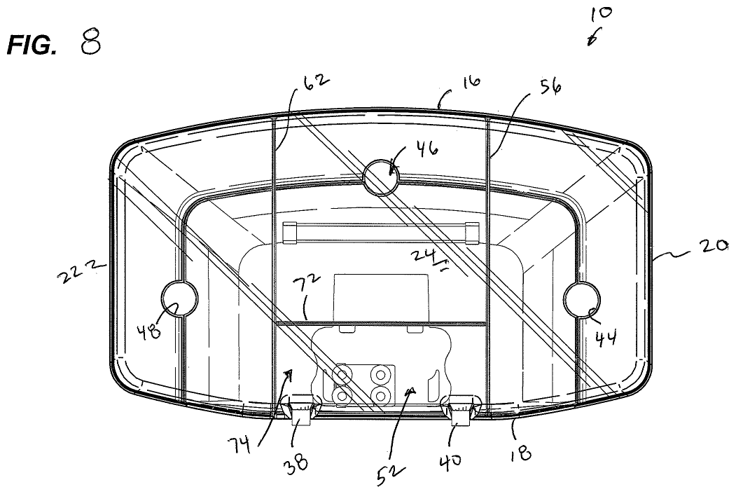

While the canopy 28 can be made from a variety of materials, in preferred embodiments, the canopy 28 is made from plastic or glass. FIG. 2 shows one preferred construction for the canopy 28. In FIG. 2, the canopy 28 is shown in an exploded, perspective view as having a perimeter rim section 32 and a cover section 34.

The perimeter rim section 32 is oriented against an upper edge 36 (FIG. 2) of the tank 12, along the side walls 20, 22 and front wall 16. The cover section 34 is sized to fit against the perimeter rim section 32 and cover the substantial majority of the top of the tank 12.

The cover section 34 is pivotably attached to the rear wall 18 by way of a pair of hinges 38, 40. In this manner, the interior volume 26 of the tank 12 can be accessed by lifting the cover section 34 and pivoting it about the rear wall 18 using the hinges 38, 40.

As can also be seen in the FIGS., the rim section 32 and cover section 34 meet at a joint 42. The joint 42 defines a plurality of holes or openings, in this case, three openings 44, 46, 48. The openings 46, 44, 48 allow for access to compartmentalized portions of the interior volume 26, without having to lift the cover section 34. For example, food can be dispersed through each of the openings 44, 46, 48.

The aquarium 10 further includes a lighting assembly 50 (FIG. 9). The lighting assembly 50 can be optionally secured to the interior portion 30 of the canopy 28. In some embodiments, the lighting assembly 50 will include LED lights. Other types of lights are possible.

The aquarium 10 further includes a filter arrangement 52 in communication with the interior volume 26 of the tank 12. The filter arrangement 52 can be located in a variety of positions within the tank 12. In the example embodiment shown, the filter arrangement 52 is against the rear wall 18. The type of filter arrangement 52 can be any of a variety of arrangements that will clean the water within the tank 12. In the preferred embodiment, the filter arrangement 52 will result in a waterfall in the interior volume 26 of the tank 12. The filter arrangement 52 can be, for example, any of the types described in any of the following patents: U.S. Pat. Nos. 6,797,163; 7,241,379; 7,316,775; and 9,888,672, each of these patents being incorporated herein by reference.

In accordance with principles of this disclosure, the aquarium 10 includes at least a first opaque panel 56 in the interior volume 26 and dividing the interior volume 26 into at least two separate compartments 58, 60.

In the example shown, the aquarium 10 further includes a second opaque panel 62 in the interior volume 26 and spaced from the first opaque panel 56, to divide the interior volume into three separate compartments 58, 60, 64.

The opaque panels 56, 62 will allow the aquarium 10 to hold certain types of fish that can become hostile to each other if they see each other. For example, betta fish need to be separated from each other and not allowed to see each other so that physical fighting does not occur.

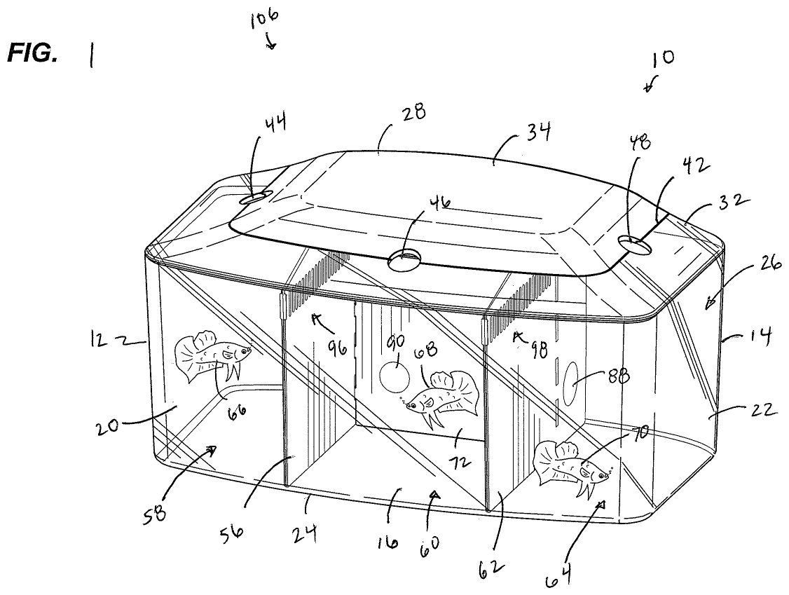

In the example shown in FIG. 1, there is a first fish 66 in the first compartment 58, a second fish 68 in the second compartment 60, and a third fish 70 in the third compartment 64. While the fish 66, 68, 70 are illustrated as being betta fish, it should be understood that the compartments 58, 60, 64 can hold any type of aquatic animal, and is particularly suited to hold aquatic animals that need be isolated from seeing other types of aquatic animals.

The opaque panels 56, 62 can be made from any material that is not transparent. In the example shown, the opaque panels 56, 62 are made from a frosted material, such as frosted glass or frosted plastic. While the panels 56, 62 can be a variety of shapes, it is preferred that they are shape that will fill in an interior perimeter of the aquarium. In this example, they have 3 straight edges including a bottom edge 56a, 62a which extends between opposite side edges 56c, 56d/62c, 62d. Each of the panels 56, 62 has an upper edge 56u, 62u, which slopes from the rear side edge 56d, 62d to the front side edge 56c, 62c.

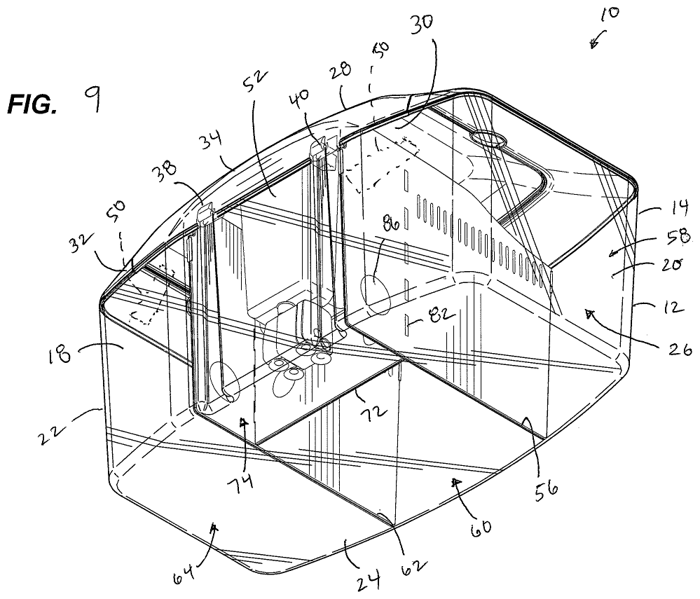

In FIG. 2, it can be seen how the aquarium 10 further includes a third panel 72. The third panel 72 extends between and connects the first opaque 56 and second opaque panel 62, such that the second compartment 60 is defined by and bordered by the first opaque panel 56, third panel 72, second opaque panel 62, and a front wall 16. The third panel 72 may or may not be opaque. One of the main purposes of the third panel 72 is to define a filter chamber 74 (FIG. 8), and help protect the second compartment 60 from the filter arrangement 52.

As can be seen in FIG. 8, the filter arrangement 52 is positioned in the filter chamber 74, which is defined by a volume between the rear wall 18 of the surrounding wall 14 and the third panel 72.

The third panel 72 includes a connection arrangement along opposite sides 76, 78 forming a releasable attachment with the first opaque panel 56 and second opaque panel 62. The connection arrangement can include a variety of implementations, and in this embodiment, the connection arrangement includes a plurality of tabs 80 projecting from the opposite side edges 76, 78 of the third panel 72. Receiving slots 82, 84, which are sized to receive the tabs 80, are defined by the first opaque panel 56 and second opaque panel 62, respectively. The receiving slots 82, 84 extending from the upper edge 56u, 62u to the bottom edge 56a, 62a.

The third panel 72 further includes a recessed edge 73 (FIG. 2) along an upper edge to accommodate portions of the filter arrangement 52.

Each of the first opaque panel 56 and second opaque panel 62 includes a filtered through opening 86, 88, respectively. The filtered through opening 86 is located on the first opaque panel 56 such that it extends between the first compartment 58 and the filter chamber 74. The filtered through opening 88 on the second opaque panel 62 is located on the second opaque panel 62 to extend between the third compartment 64 and the filter chamber 74.

The third panel 72 includes at least one, and in this example two, filtered through openings 90, 92. The filtered through openings 90, 92 extend between the second compartment 60 and the filter chamber 74.

Still in reference to FIG. 2, it can be seen how each of the first opaque panel 56 and second opaque panel 62 includes a plurality of apertures or through slots 96, 98 adjacent the upper edges 56u, 62u of the first panel 56 and second panel 62, respectively. These through slots 96, 98 allow for the flow of water to circulate within the tank 12 and between the compartments 58, 60, 64, while still blocking the vision of the fish 66, 68, 70 from each other within the compartments.

The aquarium 10 can be part of a system 106, which includes the tank 12 holding water, as well as fish 66, 68, 70.

The above represents example principles. Many embodiments can be made using these principles.

What is claimed is:

1. An aquarium comprising:
(a) a tank having an outer surrounding wall defining an interior volume;
(b) at least a first opaque panel in the interior volume and dividing the interior volume into at least 2 separate compartments;
(c) a canopy covering the tank; the canopy having an interior portion facing the interior volume of the tank;
(d) a lighting assembly secured to the interior portion of the canopy; and
(e) a filter arrangement in communication with the interior volume of the tank.

2. The aquarium of claim 1 further comprising a second opaque panel in the interior volume and spaced from the first opaque panel, to divide the interior volume into 3 separate compartments; the 3 separate compartments including a first compartment, second compartment, and third compartment.

3. The aquarium of claim 1 wherein the first opaque panel comprises a frosted panel.

4. The aquarium of claim 2 wherein both the first opaque panel and second opaque panel comprises a frosted panel.

5. The aquarium of claim 1 wherein the first opaque panel includes a first through opening covered with a filter.

6. The aquarium of claim 1 wherein the first opaque panel includes a plurality of through slots adjacent an upper edge of the first panel.

7. The aquarium of claim 2 further including a third panel extending between and connecting the first opaque panel and second opaque panel, such that the second compartment is defined by the first opaque panel, third panel, second opaque panel, and a portion of the surrounding wall of the tank.

8. The aquarium of claim 7 wherein the filter arrangement in positioned in a filter chamber defined between a portion of the surrounding wall and the third panel.

9. The aquarium of claim 7 wherein the third panel has a connection arrangement along opposite side edges forming a releasable attachment with the first opaque panel and second opaque panel.

10. The aquarium of claim 9 wherein the connection arrangement includes a plurality of tabs projecting from the opposite side edges of the third panel and slots defined by the first opaque panel and second opaque panel.

11. The aquarium of claim 8 wherein:
(a) the first opaque panel includes a first through opening covered with a filter; the first through opening extending between the first compartment and the filter chamber;
(b) the second opaque panel includes a second through opening covered with a filter; the second through opening extending between the third compartment and the filter chamber; and
(c) the third panel includes at least a third through opening covered with a filter; the third through opening extending between the second compartment and the filter chamber.

12. The aquarium of claim 11 wherein the third panel includes a fourth through opening covered with a filter; the fourth through opening extending between the second compartment and the filter chamber.

13. The aquarium of claim 2 wherein:
(a) the first opaque panel includes a plurality of through slots adjacent an upper edge of the first opaque panel; and
(b) the second opaque panel includes a plurality of through slots adjacent an upper edge of the second opaque panel.

14. The aquarium of claim 1 wherein the canopy and the tank each comprises plastic.

15. The aquarium of claim 1 wherein the lighting assembly includes LED lights.

16. The aquarium of claim 1 wherein the filter arrangement includes a waterfall in the interior volume of the tank.

17. The aquarium of claim 1 wherein the canopy is pivotably attached to the tank.

18. An aquarium system comprising:
(a) a tank having an outer surrounding wall defining an interior volume; the tank holding water;
(b) at least a first opaque panel in the interior volume and dividing the interior volume into at least first and second compartments;
(c) a canopy covering the tank; the canopy having an interior portion facing the interior volume of the tank;
(d) a lighting assembly secured to an interior portion of the canopy;
(e) a filter arrangement in communication with the interior volume of the tank; and
(f) a first fish in the first compartment; and
(g) a second fish in the second compartment;
wherein the first opaque panel precludes the first fish and second fish from seeing each other.

19. The aquarium system of claim 18 further comprising:
(a) a second opaque panel in the interior volume and spaced from the first opaque panel, to further divide the interior volume into a third compartment; and
(b) a third fish in the third compartment.

20. The aquarium system of claim 18
wherein the first fish and second fish are Betta fish.
